(19) United States
(12) Patent Application Publication
(10) Pub. No.: US 2026/0269473 A1
(43) Pub. Date: Sep. 10, 2026

(54) ANTENNA STRUCTURE AND COMMUNICATION SYSTEM

(71) Applicants: Beijing BOE Technology Development Co., Ltd., Beijing (CN); BOE Technology Group Co., Ltd., Beijing (CN)

(72) Inventors: Yifan YU, Beijing (CN); Shihua WANG, Beijing (CN); Youjian HU, Beijing (CN); Zibo CAO, Beijing (CN); Jie YANG, Beijing (CN)

(21) Appl. No.: 19/167,856

(22) PCT Filed: Apr. 29, 2024
(86) PCT No.: PCT/CN2024/090613

§ 371 Date: Sep. 23, 2025

(30) Foreign Application Priority Data
May 31, 2023 (CN) 202310639704.2

(51) Int. Cl. H01Q 5/385; H01Q 1/24; H01Q 1/42; H01Q 9/04; H01Q 9/16; H01Q 15/14; H01Q 19/10

(52) U.S. Cl. CPC H01Q 5/385; H01Q 9/045; H01Q 9/16; H01Q 15/14; H01Q 19/10; H01Q 1/246; H01Q 1/42

(57) ABSTRACT

An antenna structure and a communication system. The antenna structure comprises an electric dipole, a magnetic dipole, and a parasitic patch, wherein the parasitic patch and the magnetic dipole are respectively arranged at two sides of the electric dipole, and the parasitic patch is arranged spaced apart from the electric dipole; and the magnetic dipole comprises a plurality of oblique patches, one end of each oblique patch is connected to the electric dipole, and the oblique patches are obliquely arranged relative to the electric dipole. The communication system comprises the antenna structure.

### CROSS-REFERENCE TO RELATED APPLICATIONS

The present application is a U.S. National Phase Entry of International Application No. PCT/CN2024/090613 having an international filing date of Apr. 29, 2024, which claims priority of Chinese Patent Application No. 202310639704.2, filed to the CNIPA on May 31, 2023 and entitled “Antenna Structure and Communication System”. Contents of the above-identified applications are incorporated into the present application by reference.

### TECHNICAL FIELD

The present disclosure relates to, but is not limited to, the field of communications technology, and particularly relates to an antenna structure and a communication system.

### BACKGROUND

At first, the base station antenna is a single-polarized antenna, with only a single channel, which is inefficient and has obvious multipath fading effect. At present, the widely used base station antenna is microstrip patch antenna. Although the microstrip patch antenna has the advantages of low profile, light weight and easy processing and the like, its bandwidth is relatively narrow and its gain is relatively low.

### SUMMARY

The following is a summary of subject matters described herein in detail. This summary is not intended to limit the protection scope of claims.

At least one embodiment of the present disclosure provides an antenna structure including an electric dipole, a magnetic dipole, and a parasitic patch, the parasitic patch and the magnetic dipole are respectively provided on two sides of the electric dipole, and the parasitic patch and the electric dipole are spaced apart from each other. The magnetic dipole includes a plurality of inclined patches, one end of an inclined patch of the plurality of inclined patches is connected with the electric dipole, and the plurality of inclined patches are inclined relative to the electric dipole.

In some exemplary embodiments, the electric dipole includes a plurality of horizontal patches that are centrally symmetrical, the horizontal patches are arranged in one-to-one correspondence with the inclined patches, and included angles between the plurality of inclined patches and corresponding horizontal patches are the same.

In some exemplary embodiments, the included angles between the inclined patches and the corresponding horizontal patches are set to α, 45°≥α>90°.

In some exemplary embodiments, the α is set to 60°.

In some exemplary embodiments, the plurality of horizontal patches are configured to be arranged symmetrically about a first point position, one end of the inclined patch is connected to one end of a horizontal patch of the plurality of horizontal patches close to the first point position, and the other end of the inclined patch extends away from the first point position.

In some exemplary embodiments, the horizontal patch is configured to have a rectangular ring shape.

In some exemplary embodiments, the parasitic patch is spaced apart from the electric dipole in a first direction, the parasitic patch is configured to be parallel to the electric dipole, and a projection of the parasitic patch in the first direction entirely falls within a range of a projection of the electric dipole in the first direction.

In some exemplary embodiments, a distance between the parasitic patch and the electric dipole is set to be 0.5 mm to 2 mm.

In some exemplary embodiments, the parasitic patch is configured to be centrally arranged with respect to the electric dipole.

In some exemplary embodiments, the parasitic patch is configured as a square plate, and a corner of the square plate is provided with a chamfer or fillet.

In some exemplary embodiments, a radome and a metal reflective plate are further included, the electric dipole, the magnetic dipole, and the parasitic patch are all positioned between the radome and the metal reflective plate, and the inclined patch is connected to the metal reflective plate.

In some exemplary embodiments, a plurality of parallel rib plates are provided on the metal reflective plate, the rib plates and the magnetic dipole are located on a same side of the metal reflective plate, and the electric dipole, the magnetic dipole, and the parasitic patch are all provided between two adjacent rib plates.

In some exemplary embodiments, a plurality of insulating posts are further included, one end of an insulating post of the plurality of insulating posts is connected to the parasitic patch and the other end of the insulating post is connected to the metal reflective plate, and the insulating post is configured to support the parasitic patch.

In some exemplary embodiments, a feeding unit and a feedline are further included, the feeding unit includes two feeding probes, and one end of the feedline penetrates the metal reflective plate and is connected to one end of a feeding probe of the two feeding probes. Four inclined patches are provided, the four inclined patches are configured to be equally divided into two groups, and two inclined patches in each group are configured to be symmetrical with respect to the first point position. The two feeding probes are arranged in one-to-one correspondence with the two groups of inclined patches.

In some exemplary embodiments, the feeding probe includes a connecting plate, a first connecting arm, an intermediate arm, and a second connecting arm that are sequentially connected, the connecting plate is spaced apart from the metal reflective plate, and the connecting plate is connected to the feedline. The first connecting arm is parallel to and spaced apart from one inclined patch of a group of inclined patches, and the second connecting arm is parallel to and spaced apart from the other inclined patch of the group of inclined patches. The intermediate arm of one of the feeding probes is configured to be spaced apart from the intermediate arm of the other of the feeding probes.

In some exemplary embodiments, the electric dipole, the magnetic dipole, and the parasitic patch constitute a radiation unit, a plurality of radiation units are provided, and the plurality of radiation units are arranged in an array.

At least one embodiment of the present disclosure provides a communication system including the antenna structure as described above.

Other aspects of the present disclosure may be comprehended after the drawings and the detailed descriptions are read and understood.

### BRIEF DESCRIPTION OF DRAWINGS

Accompanying drawings are used to provide an understanding of technical solutions of the present disclosure, and form a part of the specification. The accompanying drawings and embodiments of the present disclosure are adopted to explain the technical solutions of the present disclosure, and do not form limitations on the technical solutions of the present disclosure.

FIG. 1 is a schematic diagram of an antenna structure according to an embodiment of the present disclosure;

FIG. 2 is a schematic axonometric diagram of the antenna structure in FIG. 1;

FIG. 3 is an exploded schematic view of the antenna structure in FIG. 1;

FIG. 4 is a schematic diagram of an electric dipole in FIG. 1;

FIG. 5 is a schematic diagram of a magnetic dipole in FIG. 1;

FIG. 6 is a schematic diagram of a feeding probe in FIG. 3;

FIG. 7 is a schematic diagram of a first arrangement of a parasitic patch in FIG. 1;

FIG. 8 is a schematic diagram of a first arrangement of a parasitic patch according to yet another embodiment of the present disclosure;

FIG. 9 is a schematic diagram of a parasitic patch according to another embodiment of the present disclosure;

FIG. 10 is a schematic diagram of a parasitic patch according to yet another embodiment of the present disclosure;

FIG. 11 is a schematic diagram of an antenna structure according to still yet another embodiment of the present disclosure;

FIG. 12 is a schematic view of an insulating post in FIG. 11;

FIG. 13 is a schematic diagram of an insulating post according to yet another embodiment of the present disclosure;

FIG. 14 is a schematic diagram of an insulating post according to another embodiment of the present disclosure;

FIG. 15 is a schematic diagram of an antenna structure according to still yet another embodiment of the present disclosure;

FIG. 16 is a schematic diagram of an antenna structure according to still yet another embodiment of the present disclosure;

FIG. 17 is a schematic diagram of an antenna structure according to an embodiment of the present disclosure;

FIG. 18 is a schematic diagram of an electric dipole according to yet another embodiment of the present disclosure;

FIG. 19 is a schematic diagram of an electric dipole according to still yet another embodiment of the present disclosure;

FIG. 20 is a schematic diagram of S-parameter of the antenna structure in FIG. 1; and

FIG. 21 is a directional diagram of the antenna structure in FIG. 1.

Reference signs are described as follows.
1—radome, 2—parasitic patch, 3—electric dipole, 4—magnetic dipole, 5—metal reflective plate, 6—feeding unit, 7—radiation unit, 8—horizontal patch, 9—inclined patch, 10—feeding probe, 11—first through-hole, 12—first chamfered corner, 13—first point position, 14—first connecting arm, 15—intermediate arm, 16—second connecting arm, 17—chamfer, 18—fillet, 19—insulating post, 20—rib plate, 21—first assembly, 22—spacer, 23—second through-hole, 24—feedline, 25—connecting plate.

### DETAILED DESCRIPTION

To make objectives, technical solutions, and advantages of the present disclosure clearer, the embodiments of the present disclosure will be described in detail below with reference to the accompanying drawings. It is to be noted that implementations may be implemented in multiple different forms. Those of ordinary skills in the art may easily understand such a fact that implementations and contents may be transformed into various forms without departing from the purpose and scope of the present disclosure. Therefore, the present disclosure should not be explained as being limited to the contents recorded in the following implementations only. The embodiments and features in the embodiments of the present disclosure may be randomly combined with each other if there is no conflict.

Ordinal numerals “first”, “second”, “third” and the like in the specification are set not to form limits in numbers but only to avoid confusion between constituent elements.

In the specification, for convenience, expressions “central”, “above”, “below”, “front”, “back”, “vertical”, “horizontal”, “top”, “bottom”, “inside”, “outside” and the like for indicating directional or positional relationships are used to illustrate positional relationships between the constituent elements with reference to the accompanying drawings, not to indicate or imply that involved devices or elements are required to have specific orientations or are structured and operated in the specific orientations but only to easily describe the present specification and simplify the description, and thus should not be understood as limitations on the present disclosure. The positional relationships between the constituent elements may be changed as appropriate based on a direction according to which each constituent element is described. Therefore, appropriate replacements based on situations are allowed, which is not limited to the expressions in the specification.

In the specification, unless otherwise explicitly specified and defined, terms “mounting”, “coupling”, and “connection” should be understood in a broad sense. For example, a connection may be a fixed connection, or a detachable connection, or an integral connection; it may be a mechanical connection or an electrical connection; it may be a direct connection, or an indirect connection through a middleware, or an internal communication between two elements. Those of ordinary skills in the art may understand specific meanings of the above terms in the present disclosure according to specific situations.

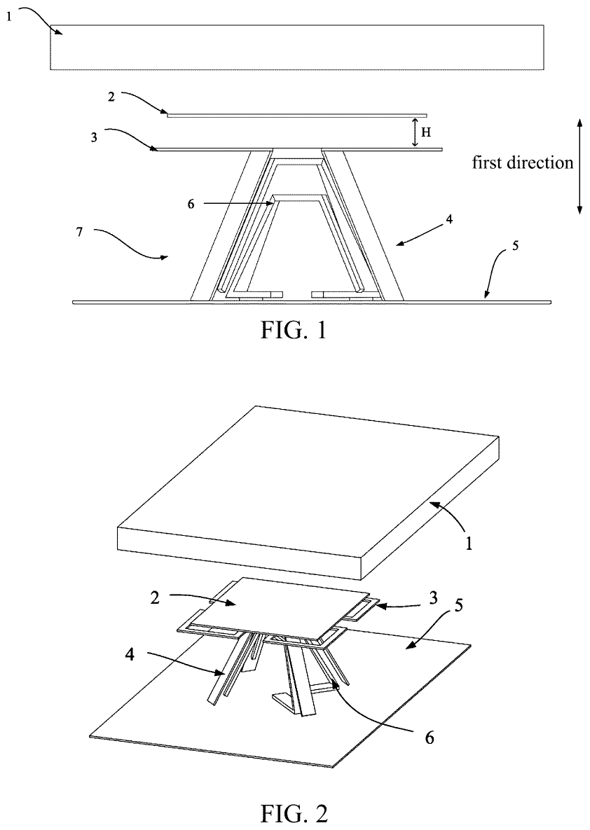

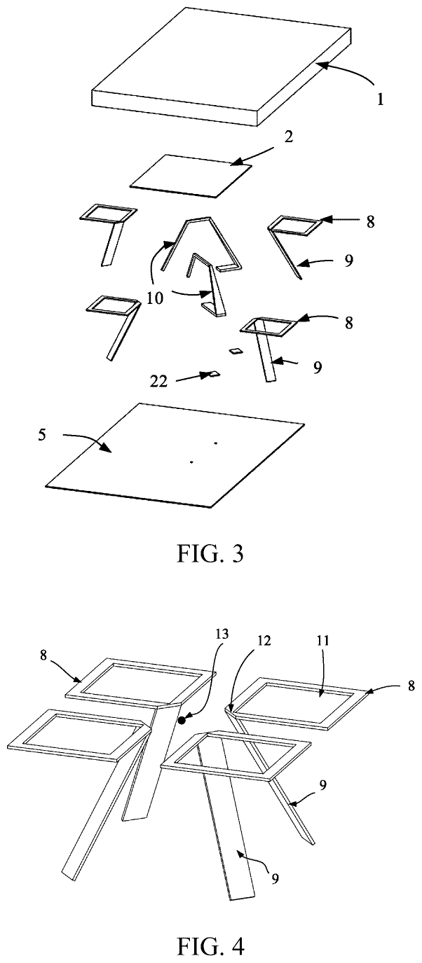

An antenna structure as shown in FIGS. 1 and 3, which can be applied to a base station antenna, includes an electric dipole 3, a magnetic dipole 4, and a parasitic patch 2. The parasitic patch 2 and the magnetic dipole 4 are respectively provided on two sides of the electric dipole 3, and the parasitic patch 2 and the electric dipole 3 are spaced apart from each other. The magnetic dipole 4 includes a plurality of inclined patches 9, one end of an inclined patch of the plurality of inclined patches 9 is connected with the electric dipole 3, and the inclined patches 9 are inclined relative to the electric dipole 3. Accordingly, the antenna structure effectively reduces the profile height of the antenna structure and reduces the occupied space of the antenna structure via the inclined patch 9 that is inclined on the premise of ensuring high gain.

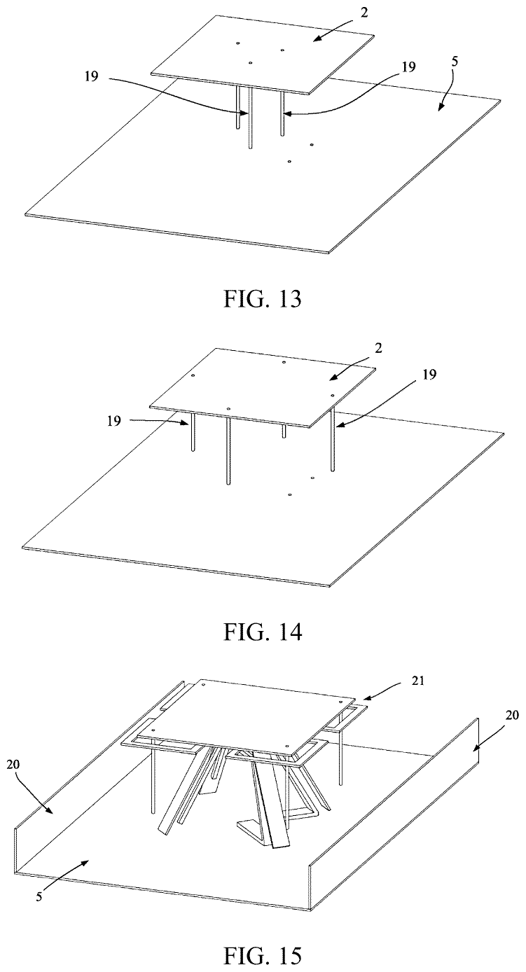

In some exemplary embodiments, as shown in FIGS. 1 and 13, the antenna structure further includes a radome 1, a feeding unit 6, and a metal reflective plate 5. The above-mentioned electric dipole 3, magnetic dipole 4, and parasitic patch 2 constitute a radiation unit 7, and the radiation unit 7 and the feeding unit 6 constitute a first assembly 21. The radome 1 and the metal reflective plate 5 form a space for accommodating the first assembly 21. A material used for the radome 1 can be NYHP7300, which is a material number, and is made of a copper-clad laminate with a dielectric constant of 3 and a loss tangent of 0.0025. This material has the advantages of low dielectric constant, high heat resistance, excellent through-hole reliability, PCB processability, low water absorption and the like. The metal reflective plate 5 may be a copper plate, the first assembly 21 is centrally arranged on the copper plate, and the above radome 1 is parallel to the metal reflective plate 5. A circumferential edge of the radome 1 may be connected to a circumferential edge of the metal reflective plate 5 to support the radome 1, which fixes a height distance between the radome 1 and the metal reflective plate 5. The connection mode of the radome 1 and the metal reflective plate 5 may be that the edge of the metal reflective plate 5 forms an upward flange, and the edge of the radome 1 corresponds to the flange and is connected to the flange by abutting or buckling, so that the radome 1 and the metal reflective plate 5 are combined together. The metal reflective plate 5 is generally arranged on the ground, and the above first assembly 21 is located in the space formed by the radome 1 and the metal reflective plate 5. The above magnetic dipole 4 is directly connected to the metal reflective plate 5, and the top of the parasitic patch 2 is separated from the radome 1 to leave a space.

In some exemplary embodiments, as shown in FIG. 4, the above electric dipole 3 includes a plurality of horizontal patches 8 that are centrally symmetrical. The number of horizontal patches 8 can be four. An outer edge of the horizontal patch 8 is generally square, and a square first through-hole 11 is provided at the center position of the horizontal patch 8. The provision of the first through-hole 11 makes each horizontal patch 8 have a rectangular ring shape, and the horizontal patch 8 in rectangular ring shape plays a role in increasing the current path, which reduces an area of an antenna structure radiator to a certain extent. The four horizontal patches 8 are in a same plane and are centrally symmetrical about a first point position 13, which is the center of symmetry. The four horizontal patches 8 are all parallel to the radome 1 and also parallel to the metal reflective plate 5, so that the whole electric dipole 3 is arranged horizontally. The four horizontal patches 8 can be divided into two groups, each group having two horizontal patches 8. The two horizontal patches 8 in each group are arranged diagonally to form a central symmetry. One corner of each horizontal patch 8 is close to the first point position 13. In order to facilitate the connection with the inclined patches 9, each horizontal patch 8 is provided with a first chamfered corner 12 at the corner close to the first point position 13, forming a chamfer, and the first chamfered corner 12 also leaves space for the feeding unit 6.

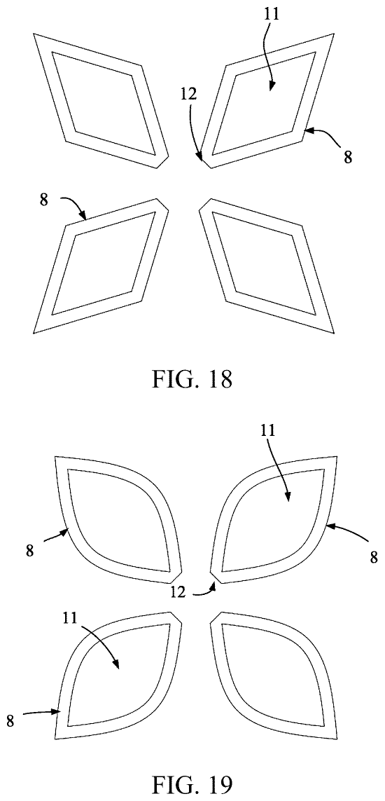

In some exemplary embodiments, as shown in FIG. 18, the outer edge of the horizontal patch 8 is generally diamond-shaped. A diamond-shaped first through-hole 11 is provided at the center position of the horizontal patch 8, and the provision of the first through-hole 11 also makes each horizontal patch 8 form a ring shape. The four horizontal patches 8 are in a same plane and are centrally symmetrical. The four horizontal patches 8 can be divided into two groups, each group has two horizontal patches 8, and the two horizontal patches 8 in each group are arranged diagonally to form a central symmetry. A corner of each horizontal patch 8 close to the center positional is machined with a first chamfered corner 12.

In some exemplary embodiments, as shown in FIG. 19, the outer edge of the horizontal patch 8 is generally leaf-shaped. A first through-hole 11 that matches the shape of the horizontal patch 8 is provided at the center position of the horizontal patch 8, and the provision of the first through-hole 11 also makes each horizontal patch 8 have a ring shape. The four horizontal patches 8 are in a same plane and are centrally symmetrical. The four horizontal patches 8 can be divided into two groups, each group has two horizontal patches 8, and the two horizontal patches 8 in each group are arranged diagonally to form a central symmetry. A corner of each horizontal patch 8 close to the center position is machined with a first chamfered corner 12. The horizontal patch 8 is not limited to the above-described square ring or diamond-shaped ring, and may be another regular ring shape as long as it meets the requirements of circuit design.

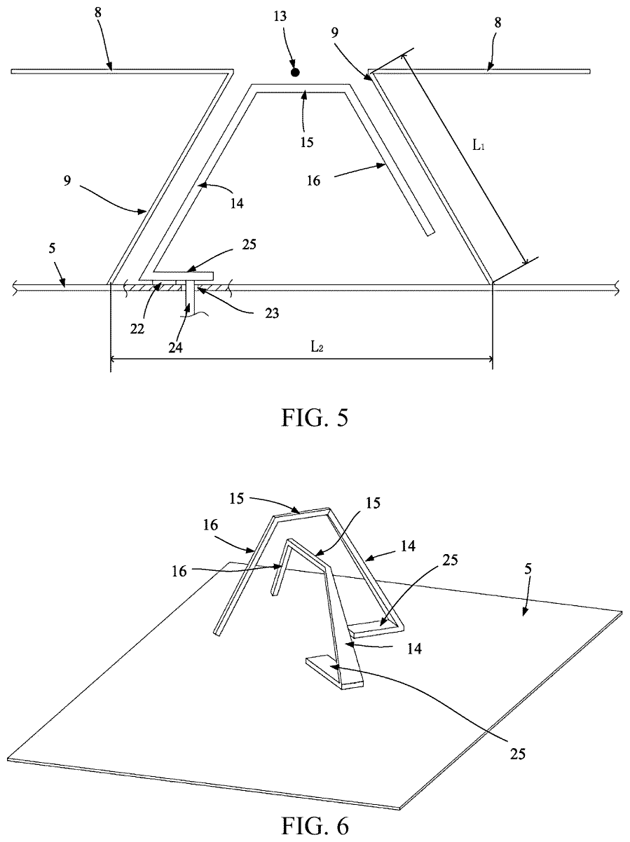

In some exemplary embodiments, as shown in FIGS. 4 and 5, FIG. 5 is a side view of an antenna structure, and the number of the above-mentioned inclined patches 9 is also four, which is the same as the number of the above-mentioned horizontal patches 8. The inclined patches 9 and the horizontal patches 8 are arranged in one-to-one correspondence. The four inclined patches 9 can be divided into two groups, and each group has two inclined patches 9. Thus, the number of both inclined patches 9 and horizontal patches 8 is four, so that the antenna structure is a dual-polarized magnetoelectric dipole antenna.

In some exemplary embodiments, as shown in FIGS. 4 and 5, the inclined patch 9 is in the shape of a long strip plate extending in a straight line. One end of the inclined patch 9 in a length direction is connected to the first chamfered corner 12 of the horizontal patch 8, and the other end of the inclined patch 9 is connected to the metal reflective plate 5. One end of the inclined patch 9 away from the horizontal patch 8 extends away from the first point position 13. Thus, the two inclined patches 9 in each group are arranged in a mirror image, and the two inclined patches 9 form an “ [symbol] ” shape. The length of the inclined patch 9 is L₁, the length of each inclined patch 9 is the same, and the distance between the ends of the two inclined patches 9 in the same group connected to the metal reflective plate 5 is L₂. The sum of the lengths of the two inclined patches 9 in the same group is 2×L₁, 2×L₁+L₂=L, and L is the total length. In order to maintain the electrical length, the total length (L) needs to satisfy a length condition, that is, the total length (L) is approximately equal to the half wavelength of the resonant frequency, so that the lengths of the two inclined patches 9 and the distance between the ends of the two inclined patches 9 in the same group connected to the metal reflective plate 5 need to be designed to satisfy the condition, so as to determine the length of the inclined patch 9 and other dimensions. The included angle between the plurality of inclined patches 9 and the corresponding horizontal patches 8 is the same, and the included angle is set to a. Since the horizontal patches 8 are parallel to the metal reflective plate 5, the included angle between the inclined patch 9 and the metal reflective plate 5 is also α. Similarly, it can be understood that the inclined angle of the inclined patch 9 with respect to the ground is a. The range of values of the included angle α may be 45°≥α>90°. Since the length of the inclined patch 9 has been determined, the larger the included angle α, the more vertical the inclined patch 9 becomes, the farther the horizontal patch 8 is from the metal reflective plate 5, and the higher the profile height of the antenna structure. The profile height of the antenna structure is the dimension of the antenna structure in the first direction. When the included angle is 90°, the inclined patch 9 is perpendicular to the ground and the horizontal patch 8, and the profile height is the highest. The smaller the included angle α, the more horizontal the inclined patch 9 becomes, the closer the horizontal patch 8 is to the metal reflective plate 5, the lower the profile height of the antenna structure, and the distance between the radome 1 and the metal reflective plate 5 is correspondingly reduced. However, if the included angle α is too small, the gain of the antenna may be affected, and in some exemplary embodiments, the value of the included angle α is 60°, which can satisfy both high gain and low profile height. However, this is not limited thereto, and for example, the value of the included angle α is 50°, the included angle between the inclined patch 9 and the corresponding horizontal patch 8 is 50°, the included angle between the inclined patch 9 and the metal reflective plate 5 is also 50°, and the inclined angle of the inclined patch 9 with respect to the ground is 50°. Thus, on the basis that the total length (L) satisfies the length condition, the length of the inclined patch 9 is determined, and the inclined patch 9 is arranged obliquely, distinguished from the vertical magnetic dipole, so that the profile height of the antenna structure is reduced to a certain extent on the basis of maintaining the electrical length, which realizes a low-profile structure of the antenna structure.

In some exemplary embodiments, as shown in FIGS. 4 and 5, both the inclined patch 9 and the horizontal patch 8 are metal members and may have the same material. The inclined patch 9 and the horizontal patch 8 are formed as an integral piece, and integrally processed and formed. One end of the inclined patch 9 away from the horizontal patch 8 is welded to the metal reflective plate 5.

In some exemplary embodiments, as shown in FIGS. 1, 2, and 7, the parasitic patch 2 and the electric dipole 3 are spaced apart from each other in the first direction, the parasitic patch 2 may be parallel to the electric dipole 3, and the parasitic patch 2 may be perpendicular to the first direction. The parasitic patch 2 is a square flat plate, and a projection of the parasitic patch 2 in the first direction entirely falls within a range of a projection of the electric dipole 3 in the first direction, i.e. the parasitic patch 2 does not protrude laterally from the outer edge of the electric dipole 3. In some exemplary embodiments, the distance between the parasitic patch 2 and the electric dipole 3 is set to H, and the value of the distance H may be 0.5 mm to 2 mm. In this example, in order to save space, the value of the distance H is 0.5 mm, but is not limited thereto, for example, H=0.7 mm. A parasitic patch 2 is added to the antenna structure, which can effectively increase the gain of the antenna, and at the same time, can improve impedance matching and expand bandwidth.

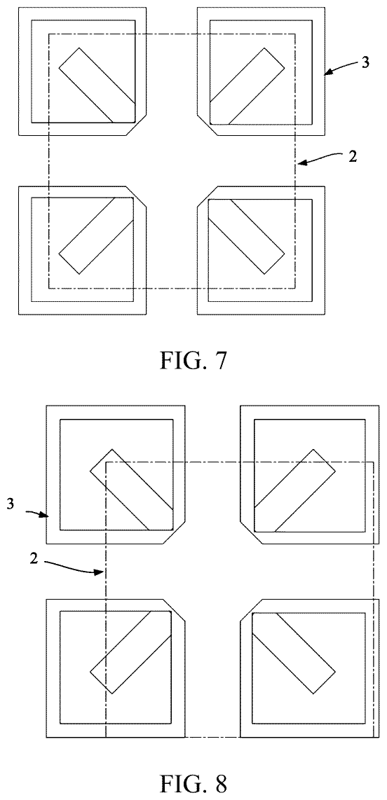

In some exemplary embodiments, as shown in FIG. 7, the parasitic patch 2 is centrally arranged with respect to the electric dipole 3, that is, the projection of the above-mentioned first point position 13 on the parasitic patch 2 is located at the center position of the parasitic patch 2. The lengths from projection edges of the parasitic patch 2 in the first direction to the corresponding projection edges of the electric dipole 3 in the first direction are consistent. As a result, the parasitic patch 2 is centrally arranged, and the antenna structure with this position layout has better matching performance and radiation performance.

In some exemplary embodiments, as shown in FIG. 8, the parasitic patch 2 is eccentrically arranged with respect to the electric dipole 3, that is, the projection of the above-mentioned first point position 13 on the parasitic patch 2 is not at the center of the parasitic patch 2. At least two of the distances between the projection edges of the parasitic patch 2 in the first direction and the corresponding projection edges of the electric dipole 3 in the first direction are different.

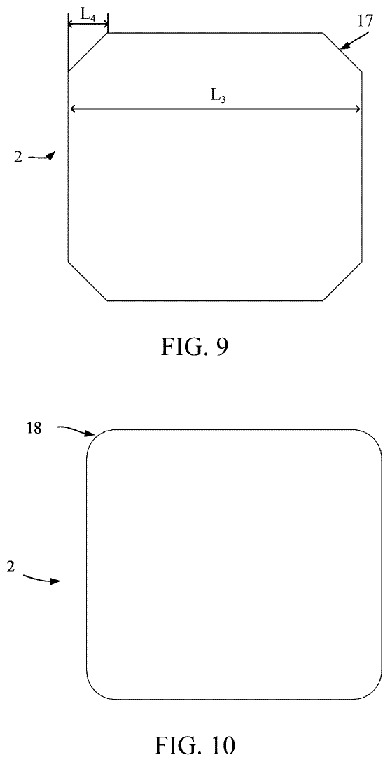

In some exemplary embodiments, as shown in FIG. 9, the parasitic patch 2 is square, the parasitic patch 2 has four corners, and the side length of the square of the parasitic patch 2 is L₃. The four corners of the parasitic patch 2 are provided with chamfers 17, and the chamfers 17 occupy a distance L₄ of the side length, and the value of L₄ is less than a quarter of the value of L₃. Accordingly, the provision of the chamfer 17 reduces the material of the parasitic patch 2, saves processing materials, and avoids the problem that the sharp corners are easily deformed without affecting the performance of the antenna. However, this is not limited to this, and the shape of the chamfer 17 may be changed. For example, it can be replaced with a triangular cutout or an arc shape, or for example, three or two of the four corners of the parasitic patch 2 have the chamfer 17, while the other corners are not machined with the chamfer 17.

In some exemplary embodiments, as shown in FIG. 10, the parasitic patch 2 is square, and the parasitic patch 2 has four corners. The corners of the parasitic patch 2 are provided with fillets 18. The fillet 18 occupies a length less than a quarter of the side length. Accordingly, the provision of the fillet 18 can reduce the material of the parasitic patch 2, saves processing materials, and avoids the problem that the sharp corners are easily deformed without affecting the performance of the antenna.

In some exemplary embodiments, as shown in FIGS. 5 and 6, the antenna further includes a feedline 24. The above feeding unit 6 includes two feeding probes 10, both of which adopt T-shaped feeding probes, and include a connecting plate 25, a first connecting arm 14, an intermediate arm 15 and a second connecting arm 16 that are sequentially connected. The connecting plate 25 is spaced apart from the metal reflective plate 5, one end of the second connecting arm 16 away from the intermediate arm 15 is a free end, and the two feeding probes 10 have the same structure but different sizes. The above connecting plate 25 has a flat plate shape, and one end of the connecting plate 25 is connected to the first connecting arm 14, and the connecting plate 25 is parallel to the intermediate arm 15. When the connecting plate 25 is mounted on the metal reflective plate 5, the connecting plate 25 is parallel to the metal reflective plate 5 and is separated from the metal reflective plate 5 by an insulating spacer 22. That is, a spacer 22 is sandwiched between the metal reflective plate 5 and the connecting plate 25 to achieve non-conductivity between the feeding probe 10 and the metal reflective plate 5. The above metal reflective plate 5 is provided with a second through-hole 23 at the position corresponding to the connecting plate 25. One end of the above feedline 24 is connected to the connecting plate 25 through the second through-hole 23, and the other end of the above feedline 24 leads out the space between the metal reflective plate 5 and the radome 1. The above feedline 24 needs to avoid the spacer 22, and the feedline 24 pulls the connecting plate 25, so that the connecting plate 25 remains parallel to the metal reflective plate 5, and thus the feeding probe 10 remains upright. The two feeding probes 10 correspond one-to-one to two groups of inclined patches 9 respectively, that is, one feeding probe 10 corresponds to two inclined patches 9 in one group, and the other feeding probe 10 corresponds to two inclined patches 9 in the other group. In each feeding probe 10 and its corresponding two inclined patches 9, a first connecting arm 14 of the feeding probe 10 is parallel to and spaced apart from one inclined patch 9 in a group of inclined patches 9, an intermediate arm 15 of the feeding probe 10 is parallel to the parasitic patch 2, and a second connecting arm 16 of the feeding probe 10 is parallel to and spaced apart from the other inclined patch 9 in a group of inclined patches 9. The distance between the first connecting arm 14 and the inclined patch 9 is equal to the distance between the second connecting arm 16 and the other inclined patch 9. In some exemplary embodiments, in addition to directly using coaxial feeding, the feeding mode of the antenna structure may also adopt the form of air microstrip lines.

In some exemplary embodiments, the spacer 22 is provided with a penetrating third through-hole (not shown in the figure), and the third through-hole (not shown in the figure) is provided corresponding to the second through-hole 23 of the metal reflective plate 5. One end of the above feedline 24 is connected to the connecting plate 25 through the second through-hole 23 and the third through-hole (not shown in the figure), and the other end of the above feedline 24 leads out the space between the metal reflective plate 5 and the radome 1. The arrangement of the third through-hole avoids the interference problem of the feedline 24 and the spacer 22 described above.

In some exemplary embodiments, as shown in FIGS. 5 and 6, there is a certain height difference between the two feeding probes 10, and the intermediate arm 15 of one feeding probe 10 is spaced apart from the intermediate arm 15 of the other feeding probe 10 to prevent mutual interference. As a result, two I-shaped feeding probes 10 are separated from each other, and two arms of each feeding probe 10 (a first connecting arm 14 and a second connecting arm 16) are parallel to the corresponding inclined patches 9 and there is an air gap between the two arm and the corresponding inclined patches 9, so as to feed the antenna radiation unit by coupling. In order to achieve a certain height difference between the two feeding probes 10, a first connecting arm 14 of one feeding probe 10 is shorter than a first connecting arm 14 of the other feeding probe 10, so that the height of the feeding probe 10 is lower.

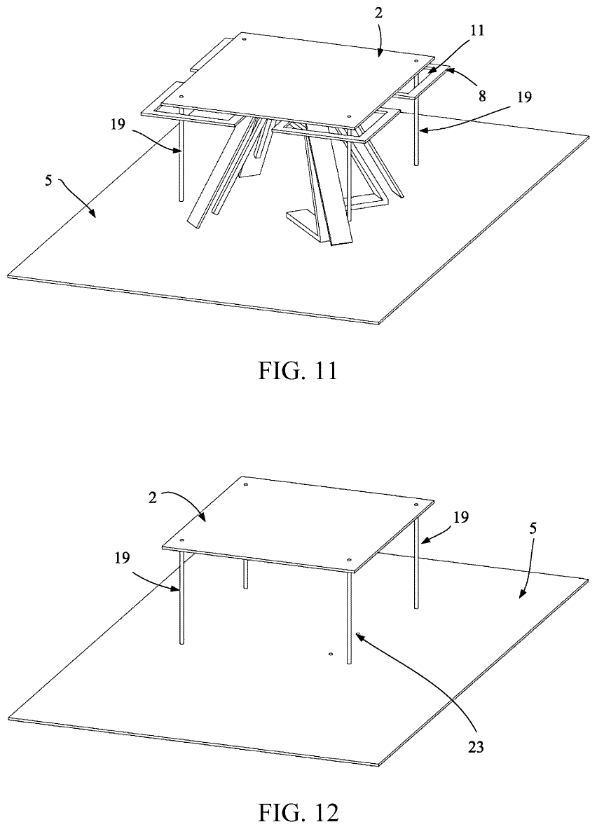

In some exemplary embodiments, as shown in FIGS. 11 and 12, the antenna structure further includes a plurality of insulating posts 19, one end of which is connected to a parasitic patch 2, and the other end of which is connected to the metal reflective plate 5 to support the parasitic patch 2. The insulating post 19 is made of PVC plastic post, which has no effect on the matching and radiation performance of the antenna. The number of insulating posts 19 is four, the length of the four insulating posts 19 is the same, the cross-sections of the insulating post 19 are all circular, and the insulating posts 19 are distributed at corners of the parasitic patch 2 for the stability of the parasitic patch 2. The insulating post 19 penetrates the first through-hole 11 of the horizontal patch 8.

In some exemplary embodiments, as shown in FIG. 13, the number of insulating posts 19 is three, the three insulating posts 19 have the same lengths, and the cross-sections of the insulating posts 19 are all circular, but not limited thereto. For example, the cross-sections of the insulating posts 19 are all rectangular, or the cross-section of one insulating post 19 is rectangular and the cross-sections of the other insulating posts 19 are circular. The insulating post 19 is vertically provided, the top of the insulating post 19 is all close to the center of a parasitic patch 2, but the insulating post 19 does not contact the horizontal patch 8, the inclined patch 9 and the feeding probe 10.

In some exemplary embodiments, as shown in FIG. 14, the number of insulating posts 19 is four, the four insulating posts 19 have the same lengths, and the cross-sections of the insulating posts 19 are all circular. The insulating posts 19 are vertically provided, the top of the insulating posts 19 is far away from the center of a parasitic patch 2, close to the edge of the parasitic patch 2, and also far away from the corner of the parasitic patch 2, so that the insulating posts 19 correspond one to one to the four sides of the parasitic patch 2. The insulating post 19 does not need to penetrate the horizontal patch 8, and it is necessary to ensure that the insulating post 19 does not come into contact with the horizontal patch 8, the inclined patch 9 and the feeding probe 10.

In some exemplary embodiments, as shown in FIG. 15, the metal reflective plate 5 is provided with a plurality of parallel rib plates 20, and the rib plates 20 are perpendicular to the metal reflective plate 5. And the rib plates 20 and the metal reflective plate 5 are integral pieces, and both are processed by the same material. Two adjacent rib plates 20 are spaced apart, the rib plates 20 and the magnetic dipole 4 are located on the same side of the metal reflective plate 5, and the first assembly 21 is between the two adjacent rib plates 20. Accordingly, the metal reflective plate 5 and the two rib plates 20 form a U-shape, and the gain of the antenna structure can be further improved. In addition, the rib plate 20 is configured to improve the strength so that the metal reflective plate 5 is less likely to be deformed.

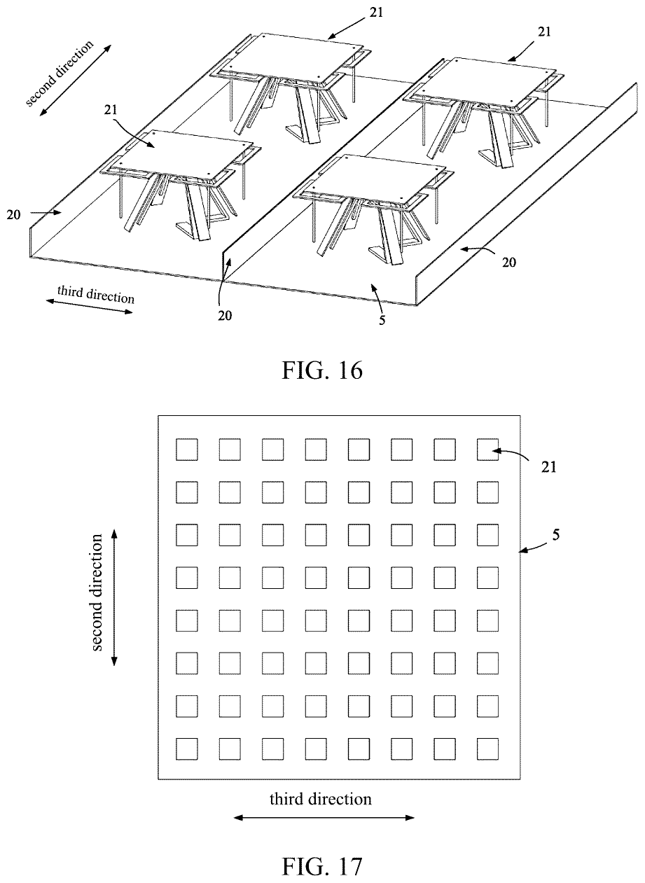

In some exemplary embodiments, as shown in FIG. 16, a plurality of parallel rib plates 20 are provided on a metal reflective plate 5, and a plurality of first assemblies 21 are also mounted on the metal reflective plate 5. The rib plates 20 all extend in a second direction and stand vertically on the metal reflective plate 5, and the plurality of rib plates 20 are arranged at equal intervals in a third direction, and the second direction and the third direction are two directions perpendicular in the horizontal direction. There are a plurality of first assemblies 21 between two adjacent rib plates 20, two adjacent first assemblies 21 in the third direction are separated by one rib plate 20, and there is no rib plate 20 separating two adjacent first assemblies 21 in the second direction. But this is not limited thereto, for example, the rib plates 20 on the metal reflective plate 5 may be arranged in a staggered manner.

In some exemplary embodiments, there are a plurality of first assemblies 21, each composed of a electric dipole 3, a magnetic dipole 4, a parasitic patch 2, a feeding unit 6, and the like. The plurality of first assemblies 21 are arranged in an array between the radome 1 and the metal reflective plate 5. In some exemplary embodiments, as shown in FIG. 17, the antenna constitutes an 8*8 antenna array, a plurality of first assemblies 21 are arranged in a plane formed by a second direction and a third direction. A plurality of first assemblies 21 arranged along the second direction constitute a column, and a plurality of first assemblies 21 arranged along the third direction constitute a row. The spacing between the first assemblies 21 in the second direction and the third direction is determined according to design requirements. But this is not limited thereto, the number of the first assemblies 21 may be determined as required, and the formed array pattern and array distance may be arranged as required.

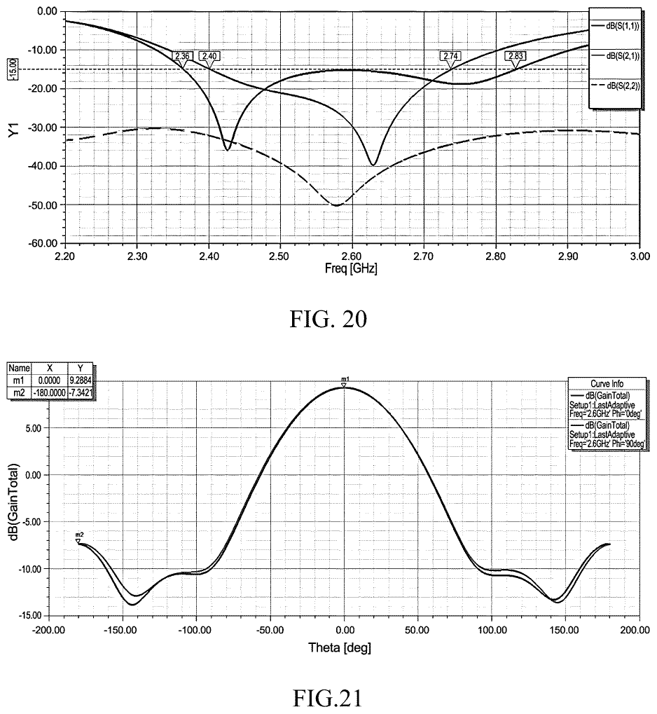

The antenna structure of this example is modeled and simulated by the simulation software High Frequency Structure Simulator (HFSS). The simulation results are shown in FIGS. 20 and 21. FIG. 20 is a schematic diagram of scattering parameters, and FIG. 21 is a directional diagram. As for S parameters, the S parameters are scattering parameters, S11 is a reflective coefficient of a port 1 when a port 2 is matched, S21 is a reflective coefficient of a port 1 to a port 2 when the port 2 is matched, and S22 is a reflective coefficient of a port 2 when a port 1 is matched. It can be seen that the bandwidths of standing waves of the two ports of the antenna less than −15 dB are from 2.36 GHz to 2.83 Ghz/from 2.40 GHz to 2.74 GHz, respectively. The antenna bandwidths respectively are 0.47 GHz/0.34 Ghz, and the bandwidths get improved with comparing to microstrip antennas. At the same time, S21 is less than −30 dB in the operating frequency band of the antenna, indicating that the isolation between the two ports of the antenna is high. As for the directional diagram, the two curves are E-plane radiation pattern and H-plane radiation pattern. The gain of this antenna reaches 9.2884 dBi, and the front-to-back ratio is 16.6305 dB. Compared with single-polarized antenna and microstrip antenna, the gain is improved and the directional diagram is stable.

In some exemplary embodiments, a communication system includes the antenna structure described above.

Combined with the above embodiments, the antenna structure adopts the structure of magnetoelectric dipoles, realizes dual-polarization, and the isolation between the two pairs of dipoles is high. The horizontal patch 8 adopts a ring structure, which plays a role in increasing the current path and reduces the area of the antenna structure radiator to a certain extent. On the basis that the total length (L) of the antenna structure satisfies the length condition, the inclined patch 9 is arranged obliquely, so that the profile height of the antenna structure is reduced to a certain extent while maintaining the electrical length, which realizes a low-profile structure of the antenna structure. The antenna structure is provided with a parasitic patch 2, which can effectively increase the gain of the antenna, and at the same time, can improve impedance matching and expand bandwidth. The whole antenna structure is cast from metal, which has a simple structure, a compact size and is convenient to process.

The above described embodiments are only illustrative of several embodiments of the present disclosure, and the description thereof is more specific and detailed, but the contents described are only embodiments adopted for the convenience of understanding the present disclosure, and are not intended to limit the present disclosure. Any person skilled in the art to which the present disclosure pertains may make any modification and variation in implementation forms and details without departing from the spirit and scope disclosed in the present disclosure. However, the scope of patent protection of the present disclosure is still subject to the scope defined by the appended claims.

1. An antenna structure comprising an electric dipole, a magnetic dipole, and a parasitic patch, wherein the parasitic patch and the magnetic dipole are respectively provided on two sides of the electric dipole, and the parasitic patch and the electric dipole are spaced apart from each other; and
the magnetic dipole comprises a plurality of inclined patches, one end of an inclined patch of the plurality of inclined patches is connected with the electric dipole, and the plurality of inclined patches are inclined relative to the electric dipole.

2. The antenna structure according to claim 1, wherein the electric dipole comprises a plurality of horizontal patches that are centrally symmetrical, the horizontal patches are arranged in one-to-one correspondence with the inclined patches, and included angles between the plurality of inclined patches and corresponding horizontal patches are the same.

3. The antenna structure according to claim 2, wherein in a second direction, the included angles between the plurality of inclined patches and the corresponding horizontal patches are set to α, 45°≥α>90°.

4. The antenna structure according to claim 3, wherein the α is set to 60°.

5. The antenna structure according to claim 2, wherein the plurality of horizontal patches are configured to be arranged symmetrically about a first point position, one end of the inclined patch is connected to one end of a horizontal patch of the plurality of horizontal patches close to the first point position, and the other end of the inclined patch extends away from the first point position.

6. The antenna structure according to claim 2, wherein a horizontal patch of the plurality of horizontal patches is configured to be of a rectangular ring shape.

7. The antenna structure according to claim 1, wherein the parasitic patch is spaced apart from the electric dipole in a first direction, the parasitic patch is configured to be parallel to the electric dipole, and a projection of the parasitic patch in the first direction entirely falls within a range of a projection of the electric dipole in the first direction.

8. The antenna structure according to claim 7, wherein a distance between the parasitic patch and the electric dipole is set to be 0.5 mm to 2 mm.

9. The antenna structure according to claim 7, wherein the parasitic patch is configured to be centrally arranged with respect to the electric dipole.

10. The antenna structure according to claim 7, wherein the parasitic patch is configured as a square plate, and a corner of the square plate is provided with a chamfer or fillet.

11. The antenna structure according to claim 5, further comprising a radome and a metal reflective plate, wherein the electric dipole, the magnetic dipole, and the parasitic patch are all positioned between the radome and the metal reflective plate, and the inclined patch is connected to the metal reflective plate.

12. The antenna structure according to claim 11, wherein a plurality of parallel rib plates are provided on the metal reflective plate, the rib plates and the magnetic dipole are located on a same side of the metal reflective plate, and the electric dipole, the magnetic dipole, and the parasitic patch are all provided between two adjacent rib plates.

13. The antenna structure according to claim 11, further comprising a plurality of insulating posts, wherein one end of an insulating post of the plurality of insulating posts is connected to the parasitic patch and the other end of the insulating post is connected to the metal reflective plate, and the insulating post is configured to support the parasitic patch.

14. The antenna structure according to claim 11, further comprising a feeding unit and a feedline, wherein the feeding unit comprises two feeding probes, and one end of the feedline penetrates the metal reflective plate and is connected to one end of a feeding probe of the two feeding probes;
four inclined patches are provided, the four inclined patches are configured to be equally divided into two groups, and two inclined patches in each group are configured to be symmetrical with respect to the first point position; and
the two feeding probes are arranged in one-to-one correspondence with the two groups of inclined patches.

15. The antenna structure according to claim 14, wherein the feeding probe comprises a connecting plate, a first connecting arm, an intermediate arm, and a second connecting arm that are sequentially connected, the connecting plate is spaced apart from the metal reflective plate, and the connecting plate is connected to the feedline;
the first connecting arm is parallel to and spaced apart from one inclined patch of a group of inclined patches, and the second connecting arm is parallel to and spaced apart from the other inclined patch of the group of inclined patches; and
the intermediate arm of one of the two feeding probes is configured to be spaced apart from the intermediate arm of the other of the two feeding probes.

16. The antenna structure according to claim 1, wherein the electric dipole, the magnetic dipole, and the parasitic patch constitute a radiation unit, a plurality of radiation units are provided, and the plurality of radiation units are arranged in an array.

17. A communication system comprising the antenna structure according to claim 1.

18. The antenna structure according to claim 2, wherein the electric dipole, the magnetic dipole, and the parasitic patch constitute a radiation unit, a plurality of radiation units are provided, and the plurality of radiation units are arranged in an array.

19. The antenna structure according to claim 3, wherein the electric dipole, the magnetic dipole, and the parasitic patch constitute a radiation unit, a plurality of radiation units are provided, and the plurality of radiation units are arranged in an array.

20. The antenna structure according to claim 4, wherein the electric dipole, the magnetic dipole, and the parasitic patch constitute a radiation unit, a plurality of radiation units are provided, and the plurality of radiation units are arranged in an array.
